(19) United States
(12) Patent Application Publication
(10) Pub. No.: US 2016/0358005 A1
(43) Pub. Date: Dec. 8, 2016

(54) TERMINAL FOR RECOGNIZING FINGERPRINT

(71) Applicant: Xiaomi Inc., Beijing (CN)

(72) Inventors: Zhongsheng JIANG, Beijing (CN); Guosheng LI, Beijing (CN); Anyu LIU, Beijing (CN)

(73) Assignee: Xiaomi Inc., Beijing (CN)

(21) Appl. No.: 15/065,382

(22) Filed: Mar. 9, 2016

(30) Foreign Application Priority Data
Jun. 3, 2015 (CN) 201510301029.8

(51) Int. Cl. G06K 9/00

(52) U.S. Cl. CPC G06K 9/0002; G06K 9/00087

(57) ABSTRACT

A terminal including a screen structure and a method are provided. The terminal includes a main body including a screen panel on a screen. The terminal includes a fingerprint reader disposed in the main body and connected to a processor. The terminal also includes one or more fingerprint detection units disposed between the screen panel and the screen. The fingerprint reader is electrically connected to the one or more fingerprint detection units respectively and electrically connected to the processor. The fingerprint reader is configured to acquire detection signals from the fingerprint detection units, generate fingerprint data according to the detection signals from the fingerprint detection units and send them to the processor. The processor is disposed inside the main body, and configured to compare the fingerprint data with stored reference fingerprint data, and perform a preset control command when the fingerprint data match with the reference fingerprint data.

The present application is based upon and claims priority to Chinese Patent Application No. 201510301029.8, filed Jun. 3, 2015, the entire contents of which are incorporated herein by reference.

### TECHNICAL FIELD

The present disclosure generally relates to the field of computer technology, and more particularly, to a terminal for recognizing a fingerprint.

### BACKGROUND

With the development of mobile terminal technology, mobile terminals have found widespread usage, and have become indispensible tools in daily lives. In order to guarantee security of user information in usage of a mobile terminal, the mobile terminal may be provided with a fingerprint recognizing function, applied in operations with relatively high security requirements such as unlocking the mobile terminal or paying online.

Typically, the mobile terminal detects an image of a fingerprint through a fingerprint detector. In this regard, a corresponding detection hole is provided at a position corresponding to the fingerprint detector on the screen panel. A user may cover the detection hole with his finger, to contact the detection terminal of the fingerprint detector. Then the fingerprint detector may generate image data of the fingerprint according to the detected detection signal for the mobile terminal to recognize the fingerprint.

### SUMMARY

According to a first aspect of embodiments of the present disclosure, there is provided a terminal for recognizing a fingerprint. The terminal includes a fingerprint reader connected to a processor. The terminal further includes a main body including a screen panel on a screen. The terminal also includes one or more fingerprint detection units disposed between the screen panel and the screen. The fingerprint reader is disposed inside the main body. The fingerprint reader is electrically connected to the one or more fingerprint detection units respectively and electrically connected to the processor. The fingerprint reader is configured to acquire detection signals from the fingerprint detection units, generate fingerprint data according to the detection signals from the fingerprint detection units and send them to the processor. The processor is disposed inside the main body, and configured to compare the fingerprint data with stored reference fingerprint data, and perform a preset control command when the fingerprint data match with the reference fingerprint data.

In a second aspect, a display structure of a terminal includes a screen panel on a screen. The display structure further includes one or more fingerprint detection units disposed between the screen panel and the screen. The one or more fingerprint detection units are electrically connected to a fingerprint reader, and configured to obtain detection signals. The display structure turns on the screen when fingerprint data based on the detection signals match with reference fingerprint data.

In a third aspect, a method is provided. The method includes providing a display structure comprising a screen panel on a screen; disposing one or more fingerprint detection units between the screen panel and the screen; electrically connecting the one or more fingerprint detection units to a fingerprint reader, obtaining, by the fingerprint detection units, detection signals; and turning on the screen when fingerprint data based on the detection signals match with reference fingerprint data.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic view of a mobile terminal according to an exemplary embodiment;

FIG. 2 is a schematic view of a mobile terminal according to an exemplary embodiment;

FIG. 3 is a schematic view of a mobile terminal according to an exemplary embodiment; and

FIG. 4 is a schematic view of a mobile terminal according to an exemplary embodiment.

### NUMBER DECLARATION

| | |
|---|---|
| 1. fingerprint reader | 2. processor |
| 3. main body | 4. fingerprint detection unit |

| | | |
|---|---|---|
| 5. screen panel | 6. switch circuit | 7. screen |

Through the above accompanying drawings, the specific embodiments of the disclosure have been shown, for which a more detailed description will be given as below. These drawings and textual description are not intended to limit the scope of the concept of the disclosure in any manner, but to explain the concept of the disclosure to those skilled in the art through particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof

It should be understood, although elements may be described as terms first, second, third or the like in the present disclosure, the elements are not limited by these terms. Rather, these terms are merely used for distinguishing elements of the same type. For example, a first element can also be referred to as a second element, and similarly, a second element can also be referred to as a first element, without departing from the scope of the present disclosure. Depending on the context, as used herein, the word “if” can be interpreted as “at the time when”, “when” or “in response to.”

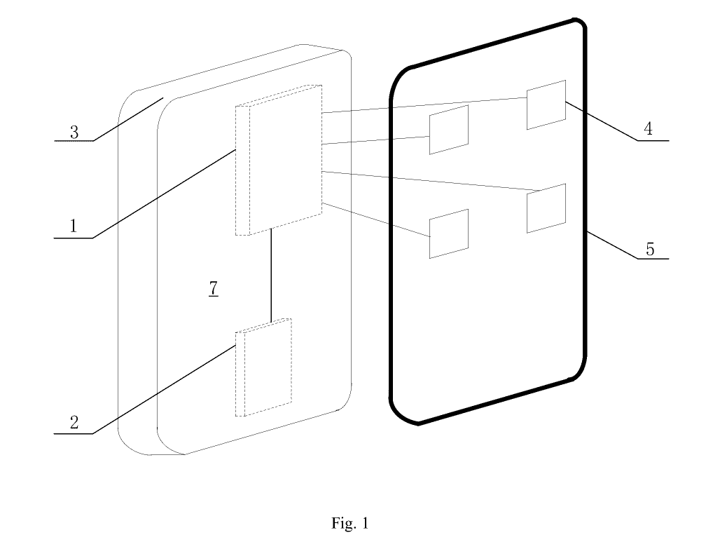

An embodiment of the present disclosure provides a terminal for recognizing a fingerprint. As shown in FIG. 1, the terminal includes a fingerprint reader 1, a processor 2, a main body 3 and one or more fingerprint detection units 4. The one or more fingerprint detection units 4 include circuitry to perform fingerprint detection.

Here, the one or more fingerprint detection units 4 are distributed between a screen panel 5 of the main body 3 and the screen 7; the fingerprint reader 1 is disposed inside the main body 3, electrically connected to the fingerprint detection units 4 respectively and electrically connected to the processor 2, and configured to acquire detection signals from the fingerprint detection units 4, generate fingerprint data according to the detection signals from the fingerprint detection units 4 and send them to the processor 2; and the processor 2 is disposed inside the main body 3, and configured to compare the fingerprint data with previously stored reference fingerprint data, and perform a preset control command if the fingerprint data matches with the reference fingerprint data.

In the embodiment of the present disclosure, the terminal includes a fingerprint reader, a processor, a main body and one or more fingerprint detection units. Specifically, the one or more fingerprint detection units are distributed between a screen panel of the main body and the screen; the fingerprint reader is disposed inside the main body, electrically connected to the fingerprint detection units respectively and electrically connected to the processor, and configured to acquire detection signals from the fingerprint detection units, generate fingerprint data according to the detection signals from the fingerprint detection units and send them to the processor; and the processor is disposed inside the main body, and configured to compare the fingerprint data with previously stored reference fingerprint data, and perform a preset control command if the fingerprint data matches with the reference fingerprint data. Thereby, the terminal may recognize a fingerprint according to the detection signals from the fingerprint detection units disposed between the screen panel and the screen, and it may eliminate the need to provide a detection hole on the screen panel. Therefore, the strength of the screen panel may be enhanced.

An embodiment of the present disclosure provides a terminal for recognizing a fingerprint. The terminal includes a fingerprint reader 1, a processor 2, a main body 3 and one or more fingerprint detection units 4. For example, the one or more fingerprint detection units 4 may be distributed between a screen panel 5 of the main body 3 and the screen 7; the fingerprint reader 1 is disposed inside the main body 3, electrically connected to the fingerprint detection units 4 respectively and electrically connected to the processor 2, and configured to acquire detection signals from the fingerprint detection units 4, generate fingerprint data according to the detection signals from the fingerprint detection units 4 and send them to the processor 2; and the processor 2 is disposed inside the main body 3, and configured to compare the fingerprint data with previously stored reference fingerprint data, and perform a preset control command if the fingerprint data matches with the reference fingerprint data.

In an embodiment, the terminal may include a fingerprint reader 1, a processor 2, a main body 3 and one or more fingerprint detection units 4. The fingerprint detection units 4 may be made of one or more of the following material: nanosilver, carbon nanotubes and graphene, or may include copper wire. Metal wires of nanoscale may be made of the above materials and distributed between the screen panel 5 of the main body 3 and the screen. For example, the fingerprint detection units 4 may be directly disposed between the screen panel 5 and the screen and arranged according to a certain pattern. The screen panel 5 of the terminal may be a flat structure without any hole. Thereby, the strength of the panel may be enhanced, and it may prevent the screen panel from being broken when the terminal falls off. The fingerprint reader 1 may be disposed inside the main body 3, electrically connected to the fingerprint detection units 4 between the screen panel 5 and the screen respectively and electrically connected to the processor 2. The processor 2 may be disposed between the main body 3 and the screen. The fingerprint reader 1 may be provided with a signal filtering system, an amplifier circuit, an Analog Digital (AD) sampling module or the like, to filter and amplify the detection signals from the fingerprint detection units 4. Then the fingerprint reader 1 generates fingerprint data according to the detection signals from the fingerprint detection units 4 and sends them to the processor 2.

Reference fingerprint data may be previously stored in the processor 2. The reference fingerprint data may be an average value of fingerprint data of a user which are detected at multiple times. The user may click a fingerprint setting option in a fingerprint setting page of the terminal. The terminal then receives a fingerprint setting instruction, and then the fingerprint reader 1 of the terminal may acquire the detection signals from the fingerprint detection units 4, generate fingerprint data, and send the fingerprint data to the processor 2. The processor 2 may store the received fingerprint data. As such, the terminal may detect the fingerprint of the user for multiple times, and send the detected fingerprint data to the processor 2. After it receives these fingerprint data, the processor 2 may determine an average value of these fingerprint data as the reference fingerprint data.

After it receives fingerprint data sent by the fingerprint reader, the processor 2 may compare the received fingerprint data with the previously stored reference fingerprint data, to determine similarity between the received fingerprint data and the reference fingerprint data. If the similarity between the received fingerprint data and the reference fingerprint data is within a preset range of similarity, a preset control command may be performed. After it determines that the similarity between the received fingerprint data and the reference fingerprint data is within a preset range of similarity, the processor 2 may detect a current display state of the interface of the terminal, and perform a control command based on the current display state of the interface of the terminal. For example, after it determines that the similarity between the received fingerprint data and the reference fingerprint data is within a preset range of similarity, if it detects that the current display state of the interface of the terminal is a to-be-unlocked state, the processor 2 may perform an unlocking operation, and if it detects that the current display state of the interface of the terminal is a to-be-paid state, the processor 2 may perform a paying operation.

Alternatively or additionally, the fingerprint reader 1 may acquire capacitance values detected by the fingerprint detection units 4, and generate fingerprint data according to the capacitance values detected by the fingerprint detection units 4.

In an embodiment, a convex portion of a fingerprint may be referred to as a ridge, and a concave portion of a fingerprint may be referred to as a valley. When the user touches the screen with his finger, a distance from a ridge to the fingerprint detection units 4 is different from a distance from a valley to the fingerprint detection units 4. Since the capacitance values detected by the fingerprint detection units 4 are relevant to the distances from the detected objects to the fingerprint detection units 4, the fingerprint detection units 4 covered by the finger will generate capacitance values in ridges different from those in valleys. The fingerprint reader 1 may acquire capacitance values detected by all of the fingerprint detection units 4 between the screen panel 5 and the screen 7, then generate fingerprint data according to the capacitance values detected by the fingerprint detection units 4, and send the generated fingerprint data to the processor 2. After it receives the fingerprint data sent by the fingerprint reader, the processor 2 may compare the received fingerprint data with the previously stored reference fingerprint data, to determine similarity between the received fingerprint data and the reference fingerprint data. If the similarity between the received fingerprint data and the reference fingerprint data is within a preset range of similarity, a preset control command may be performed. After it determines that the similarity between the received fingerprint data and the reference fingerprint data is within a preset range of similarity, the processor 2 may detect a current display state of the interface of the terminal, and perform a control command based on the current display state of the interface of the terminal.

Alternatively or additionally, the one or more fingerprint detection units 4 may be distributed between the screen panel 5 of the main body 3 and the screen in a form of a preset array.

In practice, the one or more fingerprint detection units 4 may be evenly distributed between the screen panel 5 of the main body 3 and the screen in a form of a preset array, and a total detection area corresponding the fingerprint detection units 4 may cover the entire screen, such that when the user touches any portion of the screen with his finger, the terminal may recognize the fingerprint to perform a preset control command. The fingerprint detection units 4 may be distributed between the screen panel 5 of the main body 3 and the screen in various forms, and two feasible distribution forms are described as follows.

In a first form, the one or more fingerprint detection units 4 are distributed between the screen panel 5 of the main body 3 and the screen in a form of a dot array.

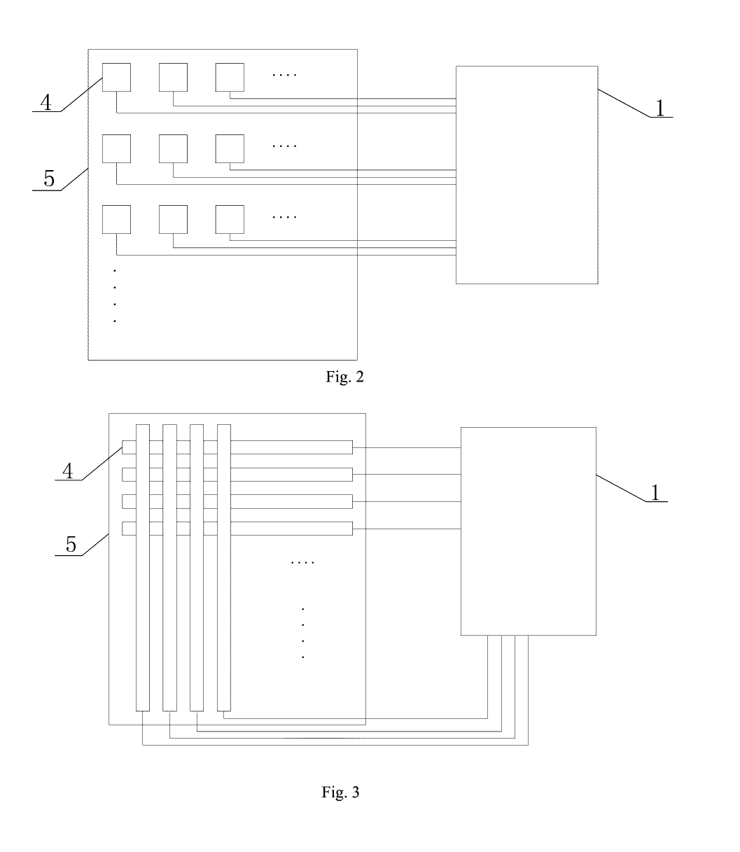

In an embodiment, each of the fingerprint detection units 4 may be a dot-shaped fingerprint detection unit 4. For example, the fingerprint detection unit 4 may be designed of a round dot shape or a square dot shape, and the fingerprint detection units 4 are evenly distributed between the screen panel 5 of the main body 3 and the screen in a form of a dot array, that is, distributed with a fixed row interval and a fixed column interval, as shown in FIG. 2. When the user touches the screen with his finger, the dot-shaped fingerprint detection units 4 covered by the finger may send the detected capacitance values to the fingerprint reader 1, for subsequent procedures.

In a second form, at least one of the fingerprint detection units 4 may have a strip shape, and the strip-shaped fingerprint detection units 4 are distributed between the screen panel 5 of the main body 3 and the screen in a crisscross form.

In an embodiment, each of the fingerprint detection units 4 may be of a strip shape, and the one or more strip-shaped fingerprint detection units 4 may be evenly distributed between the screen panel 5 of the main body 3 and the screen in a crisscross form, as shown in FIG. 3. When the user touches the screen with his finger, fingerprint detection units 4 may send to the fingerprint reader 1 capacitance values detected at crossing junctions, for subsequent procedures.

Alternatively or additionally, a transparent film is disposed between the screen panel 5 of the main body 3 and the screen 7, and the one or more fingerprint detection units 4 may be distributed on the transparent film.

In an embodiment, a transparent film may be disposed between the screen panel 5 of the main body 3 and the screen 7, and the one or more fingerprint detection units 4 may be distributed on the transparent film. Since the transparent film may be at a low cost, it may effectively prevent waste in screen panel 5 due to mistake assembly of the fingerprint detection units 4 during production, and therefore, it may improve utilization of resources.

Alternatively or additionally, the terminal further includes a switch circuit 6 electrically connected to the one or more fingerprint detection units 4 and to the fingerprint reader 1.

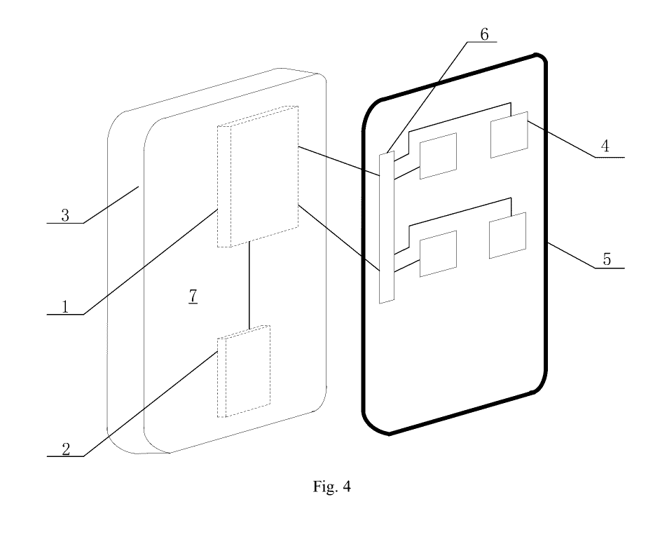

In an embodiment, as shown in FIG. 4, the terminal may be provided with a switch circuit 6. The switch circuit 6 may be provided between the screen panel 5 of the terminal and the screen 7, or may be provided on a transparent film. The switch circuit 6 may be electrically connected to the one or more fingerprint detection units 4 and to the fingerprint reader 1. The terminal may be provided with one switch circuit 6, or may be provided with one or more switch circuits 6. In case where the terminal is provided with one switch circuit 6, the switch circuit 6 may be connected to all of the fingerprint detection units 4. In case where the terminal is provided with one or more switch circuits 6, each of the one or more switch circuits 6 may be connected to a corresponding fingerprint detection unit 4.

Alternatively or additionally, the fingerprint reader 1 is further configured to send to the switch circuit 6 an instruction for acquiring detection signals; and the switch circuit 6 is configured to, when receiving an instruction for acquiring detection signals, acquire detection signals from one of the fingerprint detection units 4 in accordance with a preset order, and send the acquired detection signals to the fingerprint reader 1.

In an embodiment, the fingerprint reader 1 may send to the switch circuit 6 an instruction for acquiring detection signals at a preset time interval, and the switch circuit 6 may receive the instruction for acquiring detection signals. The switch circuit 6 may be an automatic counting switch circuit. Thus, the switch circuit 6 may count a number of the received instructions for acquiring detection signals. When receiving an instruction for acquiring detection signals, the switch circuit 6 may, based on the number of the received instructions for acquiring detection signals, acquire detection signals from one of the fingerprint detection units 4 in accordance with a preset order, and send the acquired detection signals to the fingerprint reader 1. For example, when it receives a first instruction for acquiring detection signals, the switch circuit 6 may acquire a capacitance value from a first fingerprint detection unit 4; and when it receives a second instruction for acquiring detection signals, the switch circuit 6 may acquire a capacitance value from a second fingerprint detection unit 4; and so on, so forth. After it acquires detection signals from the fingerprint detection units 4, the switch circuit 6 may send the acquired detection signals to the fingerprint reader 1, for subsequent procedures.

Alternatively or additionally, the switch circuit 6 is a thin film transistor TFT switch circuit.

In an embodiment, the switch circuit 6 may be made from a thin film transistor (TFT) process, to form a group or one or more groups of switch circuits 6. For example, the switch circuit 6 may be made from a single pixel control process for a TFT liquid crystal display (LCD). Since a switch circuit 6 made from a TFT process may have a small volume, the width of the frame may be reduced, and the external appearance of the terminal may be optimized.

In the embodiments of the present disclosure, the terminal includes a fingerprint reader, a processor, a main body and one or more fingerprint detection units. Specifically, the one or more fingerprint detection units are distributed between a screen panel of the main body and the screen; the fingerprint reader is disposed inside the main body, electrically connected to the fingerprint detection units respectively and electrically connected to the processor, and configured to acquire detection signals from the fingerprint detection units, generate fingerprint data according to the detection signals from the fingerprint detection units and send them to the processor; and the processor is disposed inside the main body, and configured to compare the fingerprint data with previously stored reference fingerprint data, and perform a preset control command if the fingerprint data matches with the reference fingerprint data. Thereby, the terminal may recognize a fingerprint according to the detection signals from the fingerprint detection units disposed between the screen panel and the screen, and it may eliminate the need to provide a detection hole on the screen panel. Therefore, the strength of the screen panel may be enhanced.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes may be made without departing from the scope thereof. It is intended that the scope of the invention only be limited by the appended claims.

What is claimed is:

1. A terminal, comprising:
a fingerprint reader connected to a processor;
a main body including a screen panel on a screen; and
one or more fingerprint detection units disposed between the screen panel and the screen; wherein:
the fingerprint reader is disposed inside the main body, electrically connected to the one or more fingerprint detection units respectively and electrically connected to the processor, and configured to acquire detection signals from the fingerprint detection units, generate fingerprint data according to the detection signals from the fingerprint detection units and send them to the processor; and
the processor is disposed inside the main body, and configured to compare the fingerprint data with stored reference fingerprint data, and perform a preset control command when the fingerprint data match with the reference fingerprint data.

2. The terminal according to claim 1, wherein the fingerprint reader is configured to acquire capacitance values detected by the fingerprint detection units, and generate fingerprint data according to the capacitance values detected by the fingerprint detection units.

3. The terminal according to claim 1, wherein the one or more fingerprint detection units are distributed between the screen panel of the main body and the screen in a form of a dot array.

4. The terminal according to claim 1, wherein at least one of the fingerprint detection units are of a strip shape, and the at least one strip-shaped fingerprint detection units are distributed between the screen panel of the main body and the screen in a crisscross form.

5. The terminal according to claim 1, wherein a transparent film is disposed between the screen panel of the main body and the screen, and the one or more fingerprint detection units are distributed on the transparent film.

6. The terminal according to claim 1, wherein the one or more fingerprint detection units comprise one or more of the following materials: nanosilver, carbon nanotubes, and graphene.

7. The terminal according to claim 1, wherein the terminal further comprises a switch circuit electrically connected to the one or more fingerprint detection units and the fingerprint reader.

8. The terminal according to claim 7, wherein the fingerprint reader is further configured to send to the switch circuit an instruction for acquiring detection signals; and
wherein the switch circuit is configured to acquire detection signals from one of the fingerprint detection units in accordance with a preset order and send the acquired detection signals to the fingerprint reader when receiving an instruction for acquiring detection signals.

9. The terminal according to claim 7, wherein the switch circuit comprises a thin film transistor TFT switch circuit.

10. The terminal according to claim 7, wherein the switch circuit comprises an automatic counting switch circuit.

11. A display structure of a terminal, comprising:
a screen panel on a screen; and
one or more fingerprint detection units disposed between the screen panel and the screen,
wherein the one or more fingerprint detection units are electrically connected to a fingerprint reader, and configured to obtain detection signals;
wherein the display structure turns on the screen when fingerprint data based on the detection signals match with reference fingerprint data.

12. The display structure according to claim 11, wherein the fingerprint reader is configured to
acquire capacitance values detected by the fingerprint detection units, and generate fingerprint data according to the capacitance values detected by the fingerprint detection units.

13. The display structure according to claim 11, wherein the one or more fingerprint detection units are distributed between the screen panel of the main body and the screen in a form of a dot array.

14. The display structure according to claim 11, wherein at least one of the fingerprint detection units are of a strip shape, and the at least one strip-shaped fingerprint detection units are distributed between the screen panel of the main body and the screen in a crisscross form.

15. The display structure according to claim 11, wherein a transparent film is disposed between the screen panel of the main body and the screen, and the one or more fingerprint detection units are distributed on the transparent film.

16. A method, comprising:
providing a display structure comprising a screen panel on a screen;
disposing one or more fingerprint detection units between the screen panel and the screen;
electrically connecting the one or more fingerprint detection units to a fingerprint reader,
obtaining, by the fingerprint detection units, detection signals; and
turning on the screen when fingerprint data based on the detection signals match with reference fingerprint data.

17. The method according to claim 16, further comprising:
acquiring capacitance values from the fingerprint detection units, and generating fingerprint data according to the capacitance values.

18. The method according to claim 16, further comprising:
distributing the one or more fingerprint detection units between the screen panel of the main body and the screen in a form of a dot array.

19. The method according to claim 16, wherein at least one of the fingerprint detection units are of a strip shape, and the at least one strip-shaped fingerprint detection units are distributed between the screen panel of the main body and the screen in a crisscross form.

20. The method according to claim 16, further comprising:
disposing a transparent film between the screen panel of the main body and the screen; and
disposing the one or more fingerprint detection units on the transparent film.
